(19) United States
(12) Patent Application Publication
(10) Pub. No.: US 2026/0268443 A1
(43) Pub. Date: Sep. 10, 2026

(54) VIDEO SUPER-RESOLUTION METHOD AND APPARATUS

(71) Applicant: DOUYIN VISION CO., LTD., Beijing (CN)

(72) Inventors: Yingjie ZHANG, Beijing (CN); Tianchun XU, Beijing (CN); Jian YU, Beijing (CN); Yi LIU, Beijing (CN); Yifan ZHU, Beijing (CN); Shijie ZHAO, Beijing (CN)

(21) Appl. No.: 18/876,195

(22) PCT Filed: Sep. 8, 2023
(86) PCT No.: PCT/CN2023/117684

§ 371 Date: Dec. 18, 2024

(30) Foreign Application Priority Data
Oct. 28, 2022 (CN) 202211335851.2

(51) Int. Cl. G06T 3/4053; G06T 3/4046

(52) U.S. Cl. CPC G06T 3/4053; G06T 3/4046

(57) ABSTRACT

A video super-resolution method, an electronic device a computer-readable storage medium are provided. The method includes obtaining an original video frame of a video to be subjected to super-resolution; obtaining pixel values of pixels in a super-resolution frame corresponding to the original video frame according to pixel values of pixels in the original video frame and a preset mapping relationship; wherein the preset mapping relationship is a mapping relationship generated according to pixel values of pixels in an input video frame of a video super-resolution network model and pixel values of pixels in an output video frame of the video super-resolution network model, and the video super-resolution network model is a model obtained by training a preset machine learning model based on a model training sample; and generating the super-resolution video frame according to the pixel values of the pixels in the super-resolution video frame.

The present application claims the priority of the Chinese patent application No. 202211335851.2 filed on Oct. 28 2022, the disclosure content of which is incorporated herein by reference in its entirety and constitutes a part of the present application.

### TECHNICAL FIELD

The embodiments of the present disclosure relate to a video super-resolution method and a video super-resolution apparatus.

### BACKGROUND

The video super-resolution technology generates a high-resolution video from a low-resolution video. Since increasing the resolution of a video can greatly improve the viewing experience of users, the video super-resolution technology is one of the hot research topics in the field of video processing.

There are two main video super-resolution schemes. One of the two schemes uses linear interpolation to up-sample the original video to improve the resolution of the video. The other scheme uses a video super-resolution network model to up-sample the original video to improve the resolution of the video. However, when video super-resolution is performed through the linear interpolation, a video output through up-sampling has low quality and poor image details, which often cannot meet the needs of users. When video super-resolution is performed through the video super-resolution network model, although the video output through up-sampling has high quality, the video super-resolution based on the video super-resolution network model consumes much computing performance, so the requirements for real-time video super-resolution cannot be met on a terminal device that runs the video super-resolution network model. In conclusion, the above technical solutions cannot meet the real-time performance and perform high-quality video super-resolution.

### SUMMARY

In view of this, the embodiments of the present disclosure provide a video super-resolution method and an apparatus that performs high-quality video super-resolution in real time.

An embodiment of the present disclosure provides a video super-resolution method, including:
obtaining an original video frame of a video to be subjected to super-resolution;
obtaining pixel values of respective pixels in a super-resolution frame corresponding to the original video frame according to pixel values of respective pixels in the original video frame and a preset mapping relationship; wherein the preset mapping relationship is a mapping relationship generated according to pixel values of pixels in an input video frame of a video super-resolution network model and pixel values of pixels in an output video frame of the video super-resolution network model, and the video super-resolution network model is a model obtained by training a preset machine learning model based on a model training sample; and
generating the super-resolution video frame according to the pixel values of the respective pixels in the super-resolution video frame.

As an optional implementation of the embodiments of the present disclosure, obtaining the pixel values of the respective pixels in the super-resolution frame corresponding to the original video frame according to the respective pixel values of the respective pixels in the original video frame and the preset mapping relationship includes:
obtaining the pixel values of the respective pixels in the super-resolution video frame corresponding to the original video frame according to the pixel values of the respective pixels in the original video frame and the preset mapping relationship based on a graphics processing unit (GPU); or
obtaining the pixel values of the respective pixels in the super-resolution video frame corresponding to the original video frame according to the pixel values of the respective pixels in the original video frame and the preset mapping relationship based on a digital signal processor (DSP); or
obtaining the pixel values of the respective pixels in the super-resolution video frame corresponding to the original video frame according to the pixel values of the respective pixels in the original video frame and the preset mapping relationship based on a graphics processing unit, a digital signal process, and a preset task assignment policy.

As an optional implementation of the embodiments of the present disclosure, obtaining the pixel values of the respective pixels in the super-resolution video frame corresponding to the original video frame according to the pixel values of the respective pixels in the original video frame and the preset mapping relationship based on the graphics processing unit (GPU) includes:
creating an input texture memory;
configuring the input texture memory so that an open computing language (OpenCL) of the GPU is capable of accessing the input texture memory;
writing the original video frame into the input texture memory;
reading the original video frame from the input texture memory through the OpenCL; and obtaining the pixel values of the respective pixels in the super-resolution video frame corresponding to the original video frame according to the pixel values of the respective pixels in the original video frame and the preset mapping relationship.

As an optional implementation of the embodiments of the present disclosure, generating the super-resolution video frame according to the pixel values of the respective pixels in the super-resolution video frame includes:
creating an output texture memory;
configuring the output texture memory so that the OpenCL is capable of accessing the input texture memory;
writing the pixel values of the respective pixels in the super-resolution video frame into the output texture memory through the OpenCL;
outputting the pixel values of the respective pixels in the super-resolution video frame from the output texture memory to a designated memory through a central processing unit CPU, and reading the pixel values of the respective pixels in the super-resolution video frame from the designated memory; and generating the super-resolution video frame according to the pixel values of the respective pixels in the super-resolution video frame.

As an optional implementation of the embodiments of the present disclosure, obtaining the pixel values of the respective pixels in the super-resolution video frame corresponding to the original video frame according to the pixel values of the respective pixels in the original video frame and the preset mapping relationship based on the digital signal processor DSP includes:
creating an input/output zero-copy ION memory;
writing the original video frame into the input ION memory;
reading the original video frame from the input ION memory through the DSP; and obtaining the pixel values of the respective pixels in the super-resolution video frame corresponding to the original video frame according to the pixel values of the respective pixels in the original video frame and the preset mapping relationship.

As an optional implementation of the embodiments of the present disclosure, obtaining the pixel values of the respective pixels in the super-resolution frame corresponding to the original video frame according to the pixel values of the respective pixels in the original video frame and the preset mapping relationship includes:
creating an output ION memory;
writing the pixel values of the respective pixels in the super-resolution video frame into the output ION memory through the DSP;
outputting the pixel values of the respective pixels in the super-resolution video frame from the output ION memory to a designated memory through the CPU, and reading the pixel values of the respective pixels in the super-resolution video frame from the designated memory through the CPU; and generating the super-resolution video frame according to the pixel values of the respective pixels in the super-resolution video frame.

As an optional implementation of the embodiments of the present disclosure, obtaining the pixel values of the respective pixels in the super-resolution frame corresponding to the original video frame according to the pixel values of the respective pixels in the original video frame and the preset mapping relationship includes:
creating a hardware buffer and an input texture memory respectively;
binding the hardware buffer to the input texture memory;
registering the hardware buffer as an ION memory through a file descriptor FD of the hardware buffer;
writing the original video frame into the input texture memory;
reading the original video frame from the input texture memory through the DSP, and obtaining the pixel values of the respective pixels in the super-resolution video frame corresponding to the original video frame according to the pixel values of the respective pixels in the original video frame and the preset mapping relationship.

As an optional implementation of the embodiments of the present disclosure, obtaining the pixel values of the respective pixels in the super-resolution frame corresponding to the original video frame according to the pixel values of the respective pixels in the original video frame and the preset mapping relationship includes:
creating an output texture memory;
binding the hardware buffer to the input texture memory;
writing the pixel values of the respective pixels in the super-resolution video frame into the output texture memory through the DSP;
outputting the pixel values of the respective pixels in the super-resolution video frame from the output texture memory into a designated memory through the CPU, reading the pixel values of the respective pixels in the super-resolution video frame from the designated memory through the CPU, and generating the super-resolution video frame according to the pixel values of the respective pixels in the super-resolution video frame.

Another embodiment of the present disclosure provides a video super-resolution apparatus which includes:
an obtaining unit, configured to obtain an original video frame of a video to be subjected to super-resolution;
a processing unit, configured to obtain pixel values of respective pixels in a super-resolution frame corresponding to the original video frame according to pixel values of respective pixels in the original video frame and a preset mapping relationship; wherein the preset mapping relationship is a mapping relationship generated according to pixel values of pixels in an input video frame of a video super-resolution network model and pixel values of pixels in an output video frame of the video super-resolution network model, and the video super-resolution network model is a model obtained by training a preset machine learning model based on a model training sample; and
a generating unit, configured to generate the super-resolution video frame according to the pixel values of the respective pixels in the super-resolution video frame.

As an optional implementation of the embodiments of the present disclosure, the processing unit is specifically configured to obtain the pixel values of the respective pixels in the super-resolution video frame corresponding to the original video frame according to the pixel values of the respective pixels in the original video frame and the preset mapping relationship based on a graphics processing unit (GPU); or obtain the pixel values of the respective pixels in the super-resolution video frame corresponding to the original video frame according to the pixel values of the respective pixels in the original video frame and the preset mapping relationship based on a digital signal processor (DSP); or obtain the pixel values of the respective pixels in the super-resolution video frame corresponding to the original video frame according to the pixel values of the respective pixels in the original video frame and the preset mapping relationship based on a graphics processing unit, a digital signal processor and a preset task assignment policy.

As an optional implementation of the present embodiment, the processing unit is specifically configured to create an input texture memory; configure the input texture memory so that an OpenCL of the GPU can access the input texture memory; write the original video frame into the input texture memory; read the original video frame from the input texture memory through the OpenCL, and obtain the pixel values of the respective pixels in the super-resolution video frame corresponding to the original video frame according to the pixel values of the respective pixels in the original video frame and the preset mapping relationship.

As an optional implementation of the embodiments of the present disclosure, the generating unit is specifically configured to create an output texture memory; configure the output texture memory so that the OpenCL can access the input texture memory; write the pixel values of the respective pixels in the super-resolution video frame into the output texture memory through the OpenCL; output the pixel values of the respective pixels in the super-resolution video frame from the output texture memory to a designated memory through a central processing unit (CPU); read the pixel values of the respective pixels in the super-resolution video frame from the designated memory; and generate the super-resolution video frame according to the pixel values of the respective pixels in the super-resolution video frame.

As an optional implementation of the embodiments of the present disclosure, the processing unit is specifically configured to create an input ION memory; write the original video frame into the input ION memory; read the original video frame from the input ION memory through the DSP, and obtain the pixel values of the respective pixels in the super-resolution video frame corresponding to the original video frame according to the pixel values of the respective pixels in the original video frame and the preset mapping relationship.

As an optional implementation of the embodiments of the present disclosure, the generating unit is specifically configured to create an output ION memory; write the pixel values of the respective pixels in the super-resolution video frame into the output ION memory through the DSP; output the pixel values of the respective pixels in the super-resolution video frame from the output ION memory to a designated memory through the CPU; read the pixel values of the respective pixels in the super-resolution video frame from the designated memory; and generate the super-resolution video frame according to the pixel values of the respective pixels in the super-resolution video frame.

As an optional implementation of the embodiments of the present disclosure, the processing unit is specifically configured to create a hardware buffer and an input texture memory; bind the hardware buffer to the input texture memory; register the hardware buffer as an ION memory through the file descriptor (FD) of the hardware buffer; write the original video frame into the input texture memory; read the original video frame from the input texture memory through the DSP, and obtain the pixel values of the respective pixels in the super-resolution video frame corresponding to the original video frame according to the pixel values of the respective pixels in the original video frame and the preset mapping relationship.

As an optional implementation of the embodiments of the present disclosure, the generating unit is specifically configured to create an output texture memory; bind the hardware buffer to the input texture memory; write the pixel values of the respective pixels in the super-resolution video frame into the output texture memory through the DSP; output the pixel values of the respective pixels in the super-resolution video frame from the output texture memory to a designated memory through the CPU; read the pixel values of the respective pixels in the super-resolution video frame from the designated memory; and generate the super-resolution video frame according to the pixel values of respective pixels in the super-resolution video frame.

Another embodiment of the present disclosure provides an electronic device, including: a memory and a processor, wherein the memory is configured to store a computer program; the processor is configured to execute the computer program that enables the electronic device to implement the video super-resolution method according any embodiment as mentioned above.

Another embodiment of the present disclosure provides a computer-readable storage medium with a computer program stored thereon, wherein the computer program, when being executed by a computing device, enables the computing device to implement the video super-resolution method according to any embodiment as mentioned above.

Another embodiment of the present disclosure provides a computer program product, where the computer program product, when being run on a computer, enables the computing device to implement the video super-resolution method provided in any embodiment as mentioned above.

The video super-resolution method provided in the embodiments of the present disclosure first parses a video to be subjected to super-resolution to obtain an original video frame of the video to be subjected to super-resolution, then obtains pixel values of pixels in a super-resolution video frame corresponding to the original video frame according to pixel values of pixels in the original video frame and a preset mapping relationship, and generates the super-resolution video frame according to the pixel values of the respective pixels in the super-resolution video frame. Since the embodiments of the present disclosure obtain the pixel values of the respective pixels in the super-resolution video frame corresponding to the original video frame according to the pixel values of the respective pixels in the original video frame and the preset mapping relationships, so that the pixel values of the respective pixels in the super-resolution video frame may be obtained without using a video super-resolution network model, the embodiments of the present disclosure consume less computing performance and can meet the requirements for real-time video super-resolution, and in addition, because the preset mapping relationship is a mapping relationship generated according to pixel values of pixels in an input video frame of the video super-resolution network model and pixel values of pixels in an output video frame of the video super-resolution network model, and the video super-resolution network model is a model obtained by training a preset machine learning model based on a model training sample, the embodiments of the present disclosure may obtain a video super-resolution effect similar to that of the video super-resolution network model, providing high-quality video super-resolution. In summary, the embodiments of the present disclosure may perform high-quality video super-resolution while satisfying the real-time performance.

### BRIEF DESCRIPTION OF DRAWINGS

The accompanying drawings herein are incorporated in and constitute a part of this specification, showing embodiments consistent with the present disclosure and are used together with the description to explain the principles of the present disclosure.

In order to illustrate the embodiments of the present disclosure more clearly, the accompanying drawings that need to be invoked in the embodiments will be briefly introduced below. Obviously, for those of ordinary skill in the art, without creative efforts, other drawings can also be obtained according to these drawings.

FIG. 1 is a step flow chart 1 of a video super-resolution method provided in an embodiment of the present disclosure;

FIG. 2 is a step flow chart 2 of a video super-resolution method provided in an embodiment of the present disclosure;

FIG. 3 is a step flow chart 3 of a video super-resolution method provided in an embodiment of the present disclosure;

FIG. 4 is a step flow chart 4 of a video super-resolution method provided in an embodiment of the present disclosure;

FIG. 5 is a step flow chart 5 of a video super-resolution method provided in an embodiment of the present disclosure;

FIG. 6 is a structural schematic diagram of a video super-resolution apparatus provided in an embodiment of the present disclosure; and

FIG. 7 is a hardware structural schematic diagram of an electronic device provided in an embodiment of this disclosure.

### DETAILED DESCRIPTION

In order to understand the above objectives, characteristics and advantages of the present disclosure more clearly, the scheme of the present disclosure will be further described below. It should be noted that in the absence of conflict, the embodiments of the present disclosure and the features in the embodiments can be combined with each other.

In the following description, many specific details are set forth to fully understand the present disclosure. However, the present disclosure can also be implemented in other ways different from those described herein. Obviously, the embodiments in the specification are only some embodiments of the present disclosure, not all of the embodiments.

In the embodiments of the present disclosure, words such as “exemplary” or “for example” are used to indicate serving as an example, illustration or explanation. Any embodiment or design scheme described as “exemplary” or “for example” in the embodiments of the present disclosure should not be construed as being more preferred or advantageous than other embodiments or design schemes. Rather, the invocation of words such as “exemplary” or “for example” is intended to present related concepts in a specific way. In addition, in the description of the embodiments of the present disclosure, unless otherwise specified, the meaning of “multiple” refers to two or more.

The embodiments of the present disclosure provide a video super-resolution method. Referring to FIG. 1, and the video super-resolution method includes the following steps S11 to S13:
S11: Obtaining an original video frame of a video to be subjected to super-resolution.

In some embodiments, the original video frame of the video to be subjected to super-resolution may be implemented through means including: using FFMpeg (Fast Forward Mpeg, an open-source computer program that can be used to record and convert digital audio and video, and transfer them into streams), OpenCV (a cross-platform computer vision and machine learning software library that can run on Linux, Windows, Android and Mac OS operating systems, and implement many general image processing and computer vision algorithms) and other programs to parse the video to be subjected to super-resolution to obtain the original video frame of the video.

In some embodiments, the original video frame of the video to be subjected to super-resolution may be obtained through means including: developing programs through programming languages such as C/C++, Python, Golang, and the like in advance, and extracting one original video frame from the video to be subjected to super-resolution at a predetermined interval through the developed program.

The video to be subjected to super-resolution in the embodiments of the present disclosure may be a video of any type. For example, the video to be subjected to super-resolution may be a 2D flat video, a 3D flat video, a virtual reality (VR) video, a spherical video, a panoramic video, a hemispherical video, or the like. When the video to be subjected to super-resolution is a 2D video, one original video frame of the video to be subjected to super-resolution includes only one view, and when the video to be subjected to super-resolution is a 3D video, one original video frame of the video to be subjected to super-resolution includes a left-eye view and a right-eye view.
S12: Obtain pixel values of respective pixels in a super-resolution video frame corresponding to the original video frame according to pixel values of respective pixels in the original video frame and a preset mapping relationship.

The preset mapping relationship is a mapping relationship generated according to pixel values of pixels in an input video frame and pixel values of pixels in an output video frame of a video super-resolution network model, and the video super-resolution network model is a model obtained by training a preset machine learning model based on a model training sample.

The video super-resolution network model in the embodiment of the present disclosure may be a model obtain by training a convolutional neural network (CNN) model, a recursive neural network (RNN) model, a generative adversarial networks (GAN) model, a recurrent neural networks model, a bidirectional recurrent neural networks (BRNN), and other machine learning models based on sample data. The sample data may include multiple low-resolution videos and high-resolution videos corresponding to respective low-resolution videos.

In some embodiments, the mapping relationship may be generated according to the pixel values of the pixels in the input video frame and the pixel values of the pixels in the output video frame of the video super-resolution network model through means including: determining a corresponding position of a pixel of the output video frame in the input video, determining respective pixels in a preset neighborhood range of the position, obtaining the pixel values of the pixels in the output video frame and the pixel values of the respective pixels in the preset neighborhood range, establishing the mapping relationship between the pixel values of the pixels in the output video frame and the pixel values of the respective pixels in the preset neighborhood range.

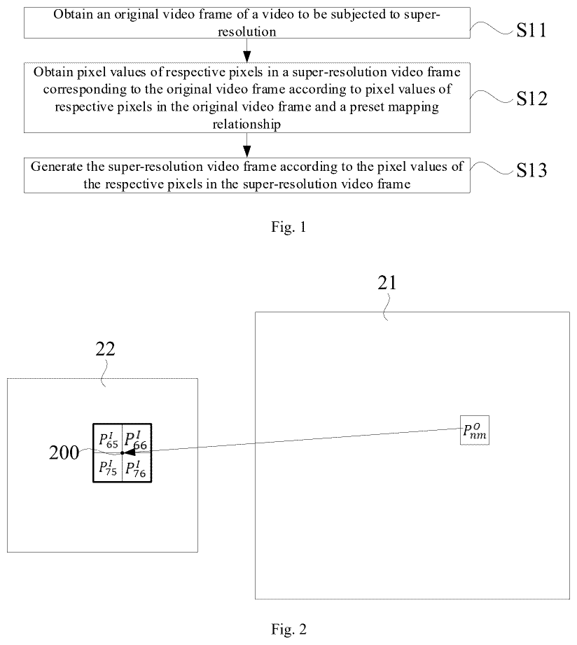

For example, as shown in FIG. 2, FIG. 2 shows an example where a pixel Pₙₘ^{O} in an output video frame 21 of the video super-resolution network model has a corresponding position 200 in an input video frame 22 of the video super-resolution network model, and the preset neighborhood range is a 2*2 neighborhood range. Since all pixels in the 2*2 neighborhood range of the position 200 include a pixel P₆₅^{I}, a pixel P₆₆^{I}, a pixel P₇₅^{I}, and a pixel P₇₆^{I}, and the pixel Pₙₘ^{I} has a pixel value of Iₙₘ^{O}, the pixel P₆₅^{I}, the pixel P₆₆^{I}, the pixel P₇₅^{I}, and the pixel P₇₆^{I} have the pixel values of I₆₅^{I}, I₆₆^{I}, I₇₅^{I} and I₇₆ⁱ, respectively, so the following correspondence may be established:
I₆₅^{I}, I₆₆^{I}, I₇₅^{I}, I₇₆^{I}→Iₙₘ^{O}

In some embodiments, according to the pixel values of the respective pixels in the original video frame and the preset mapping relationships, the pixel values of the respective pixels in the super-resolution video frame corresponding to the original video frame may be obtained through means including: determining the pixel values of the pixels in the original video frame corresponding to the pixel values of the respective pixels of the super-resolution video frame corresponding to the original video frame, and searching for the preset mapping relationship using the pixel values of the pixels in the original video frame corresponding to the pixel values of the respective pixels in the super-resolution video frame as indexes to obtain the pixel values of the respective pixels in the super-resolution video frame.

In some embodiments, the preset mapping relationship may also be converted into a mapping relationship table, and the mapping relationship table may be saved in a video super-resolution apparatus.
S13: Generate the super-resolution video frame according to the pixel values of the respective pixels in the super-resolution video frame.

In some embodiments, generating the super-resolution video frame according to the pixel values of the respective pixels in the super-resolution video frame may include: using programs such as Ffmpeg and OpenCV to splice the respective pixels in the super-resolution video frame to generate the super-resolution video frame.

In some embodiments, generating the super-resolution video frame according to the pixel values of the respective pixels in the super-resolution video frame may include: developing a program through a programming language such as C/C++, Python, and Golang in advance, and combining the respective pixels in the super-resolution video frame through the developed program to generate the super-resolution video frame.

The video super-resolution method provided in the embodiments of the present disclosure first parses a video to be subjected to super-resolution to obtain an original video frame of the video, then obtains pixel values of pixels in a super-resolution video frame corresponding to the original video frame according to pixel values of pixels in the original video frame and a preset mapping relationship, and generates the super-resolution video frame according to the pixel values of the respective pixels in the super-resolution video frame. Since the embodiments of the present disclosure obtain the pixel values of the respective pixels in the super-resolution video frame corresponding to the original video frame according to the pixel values of the respective pixels in the original video frame and the preset mapping relationships, and there is no need to obtain the pixel values of respective pixels in the super-resolution video frame through the video super-resolution network model, the embodiments of the present disclosure consume less computing performance and can meet the requirements for real-time performance of video super-resolution, and because the preset mapping relationship is a mapping relationship generated according to the pixel values of the pixels in the input video frame of the video super-resolution network model and the pixel values of the pixels in the output video frame, and the video super-resolution network model is a model obtained by training a preset machine learning model based on model training samples, the embodiments of the present disclosure can obtain a video super-resolution effect similar to that of the video super-resolution network model, providing high-quality video super-resolution. In summary, the embodiments of the present disclosure may perform high-quality video super-resolution while satisfying the real-time performance.

In some embodiments, the preceding step S12 (obtaining pixel values of the respective pixels in the super-resolution video frame corresponding to the original video frame according to the pixel values of the respective pixels in the original video frame and the preset mapping relationship) includes: obtaining the pixel values of the respective pixels in the super-resolution video frame corresponding to the original video frame according to the pixel values of the respective pixels in the original video frame and the preset mapping relationship based on a graphics processing unit (GPU).

That is, the embodiments of the present disclosure may use the GPU to obtain the pixel values of the respective pixels in the super-resolution video frame corresponding to the original video frame according to the pixel values of the respective pixels in the original video frame and the preset mapping relationship, thereby realizing the super-resolution of the video to be subjected to super-resolution.

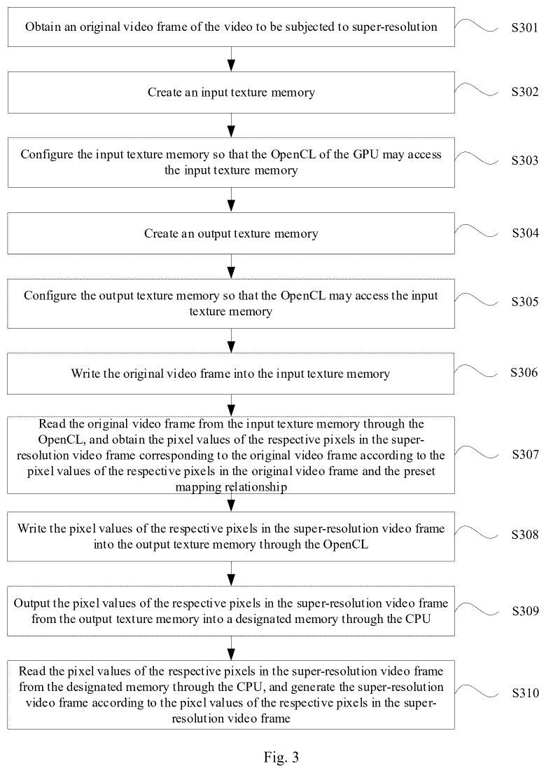

Referring to FIG. 3, when obtaining the pixel values of the respective pixels in the super-resolution video frame corresponding to the original video frame according to the pixel values of the respective pixels in the original video frame and the preset mapping relationship based on the GPU, the video super-resolution method provided in the embodiments of the present disclosure includes the following steps:
S301: Obtaining an original video frame of the video to be subjected to super-resolution;
S302: Creating an input texture memory.

Specifically, the texture memory is a dedicated memory that can be read and written by the GPU for graphical data. With respect to the hardware, the texture memory is actually a part of a global memory, and the texture memory differs from a general memory in that after a variable is bound to the texture memory, part of the information is stored in the texture memory when a program runs, so as to reduce access to the global memory by a thread block, thereby improving the running speed of the program.

In some embodiments, the input texture memory may be created through means including: creating the input texture memory through an Application Program Interface (API) of an open computing language (OpenGL, a framework for programming for heterogeneous platforms).

The size of the input texture memory in the embodiments of the present disclosure may be determined according to the data amount of one original video frame. For example, in response to the data volume of one original video frame being 5 kB, the size of the input texture memory created may be 5 kB, 10 kB, and so on.
S303: Configure the input texture memory so that the OpenCL of the GPU may access the input texture memory.

OpenGL (Open Computing Language) is a framework for writing programs for heterogeneous platforms.

In some embodiments, the input texture memory may be configured through means including: converting it to an OpenCL format memory using an extension API of the apparatus.

Because the above embodiment configures the input texture memory so that the OpenCL of the GPU can access the input texture memory, the OpenCL can directly read the video frame data of the video to be subjected to super-resolution from the input texture memory for use, and because the above processes are all carried out on the GPU, there is no need to copy the video frame data, which further improves the efficiency of video super-resolution.

It should be noted that the preceding steps S302 and S303 need to be executed only once in the process of super-resolution of the video, there is no need to execute the preceding steps S302 and S303 every time one original video frame of the video to be subjected to super-resolution is super-resolved.
S304: Create an output texture memory.

Similarly, the output texture memory may be created via the API for OpenGL.

The size of the output texture memory in the embodiments of the present disclosure may be determined according to the data amount of one super-resolution video frame. For example, in response to the data volume of the original video frame being 15 kB, the size of the input texture memory created may be 15 kB, 30 kB, and so on.
S305: Configure the output texture memory so that the OpenCL may access the input texture memory.

Similarly, the preceding steps S304 and S305 need to be executed only once in the process of super-resolution of the video, instead of executing the preceding steps S304 and S305 every time the super-resolution is performed on an original video frame of the video to be subjected to super-resolution.
S306: Write the original video frame into the input texture memory.

That is, the original video frame of the video to be subjected to super-resolution is copied to the input texture memory that can be read and written by the GPU.
S307: Read the original video frame from the input texture memory through the OpenCL, and obtain the pixel values of the respective pixels in the super-resolution video frame corresponding to the original video frame according to the pixel values of the respective pixels in the original video frame and the preset mapping relationship.

In some embodiments, the preceding step S307 may be implemented through means including the following step a to step c:
step a: reading the original video frame from the input texture memory through the OpenCL, and writing the original video frame to the cache of the GPU;
step b: reading the pixel values of the pixels of the original video frame from the cache of the GPU in parallel through the OpenCL;
step c: obtaining the corresponding output according to the pixel values of the pixels and the preset mapping relationship through the OpenCL.
S308: Write the pixel values of the respective pixels in the super-resolution video frame into the output texture memory through the OpenCL.
S309: Output the pixel values of the respective pixels in the super-resolution video frame from the output texture memory into a designated memory through the CPU.
S310: Read the pixel values of the respective pixels in the super-resolution video frame from the designated memory through the CPU, and generate the super-resolution video frame according to the pixel values of the respective pixels in the super-resolution video frame.

Through the embodiment shown in FIG. 3 above, the embodiments of the present disclosure use the GPU for heterogeneous computing to achieve high-quality video super-resolution.

In some embodiments, the preceding step S12 (obtaining the pixel values of respective pixels in the super-resolution video frame corresponding to the original video frame according to the pixel values of the respective pixels in the original video frame and the preset mapping relationship) includes: obtaining the pixel values of the respective pixels in the super-resolution video frame corresponding to the original video frame according to the pixel values of the respective pixels in the original video frame and the preset mapping relationship based on a digital signal processor (DSP).

Specifically, the digital signal processor is a microprocessor that uses digital signals to process a large amount of information.

That is, the embodiments of the present disclosure may use the DSP to obtain the pixel values of the respective pixels in the super-resolution video frame corresponding to the original video frame according to the pixel values of the respective pixels in the original video frame and the preset mapping relationship to obtain video super-resolution.

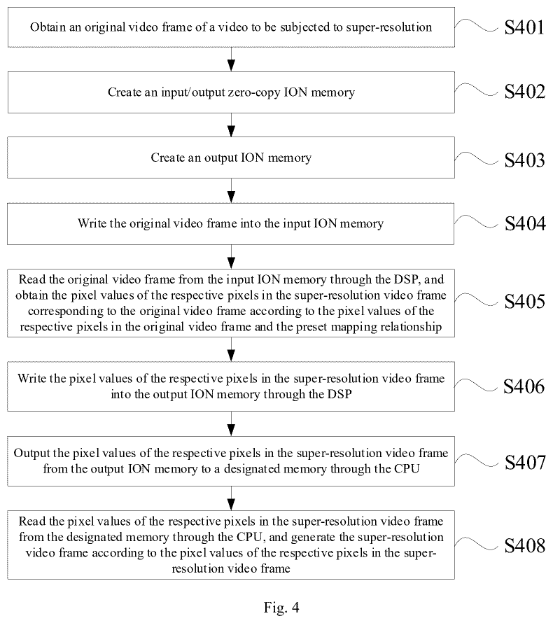

Referring to FIG. 4, when obtaining the pixel values of the respective pixels in the super-resolution video frame corresponding to the original video frame according to the pixel values of the respective pixels in the original video frame and the preset mapping relationship based on the DSP, the video super-resolution method provided in the embodiments of the present disclosure includes the following steps:
S401: Obtaining an original video frame of a video to be subjected to super-resolution;
S402: Creating an input/output zero-copy ION memory.

Specifically, the ION memory is a memory that can be read and written by the DSP. The ION is a set of mechanisms allocated and managed by a Linux bulk memory and a general-purpose memory manager introduced to solve memory fragmentation management, and the memory by ION becomes an ION memory. The Android operating system has introduced the ION memory manager based on a Linux kernel-based memory management mechanism. The goal of ION design is to avoid memory fragmentation, or for some applications with special memory requirements, such as cameras, video players, or the like, for which certain memory pools, referred to as ION pools, will be reserved when the system starts, and the ION memory of the ION pool is managed by ION.
S403: Create an output ION memory.

It should be noted that the preceding steps S402 and S403 need to be executed only once in the process of super-resolution of the video, instead of executing the preceding steps S402 and S403 every time the super-resolution is performed an original video frame of the video to be subjected to super-resolution.
S404: Write the original video frame into the input ION memory.

That is, the original video frame of the video to be subjected to super-resolution is copied to the input ION memory that can be read and written by the DSP.

S405: Read the original video frame from the input ION memory through the DSP, and obtain the pixel values of the respective pixels in the super-resolution video frame corresponding to the original video frame according to the pixel values of the respective pixels in the original video frame and the preset mapping relationship.

In some embodiments, the preceding step S405 (reading the original video frame from the input ION memory through the DSP, and obtaining the pixel values of the respective pixels in the super-resolution video frame corresponding to the original video frame according to the pixel values of the respective pixels in the original video frame and the preset mapping relationship) may be implemented through means including the following step 1 to step 3.
Step 1: Expose an on-chip memory and write the preset mapping relationship to the on-chip memory.
Step 2: Read the pixel values of the pixels of the original video frame by line through a DSP cache prefetch mechanism.

In some embodiments, the pixel values of the next line of pixels may also be read to a L2 cache during the execution of super-resolution operations to hide time of data transfer.
Step 3: Execute the Single Instruction Multiple Data (SIMD) command to achieve image super-resolution.
S406: Write the pixel values of the respective pixels in the super-resolution video frame into the output ION memory through the DSP.
S407: Output the pixel values of the respective pixels in the super-resolution video frame from the output ION memory to a designated memory through the CPU.
S408: Read the pixel values of the respective pixels in the super-resolution video frame from the designated memory through the CPU, and generate the super-resolution video frame according to the pixel values of the respective pixels in the super-resolution video frame.

Through the embodiment shown in FIG. 4 above, the embodiments of the present disclosure use the DSP for heterogeneous computing to achieve high-quality video super-resolution.

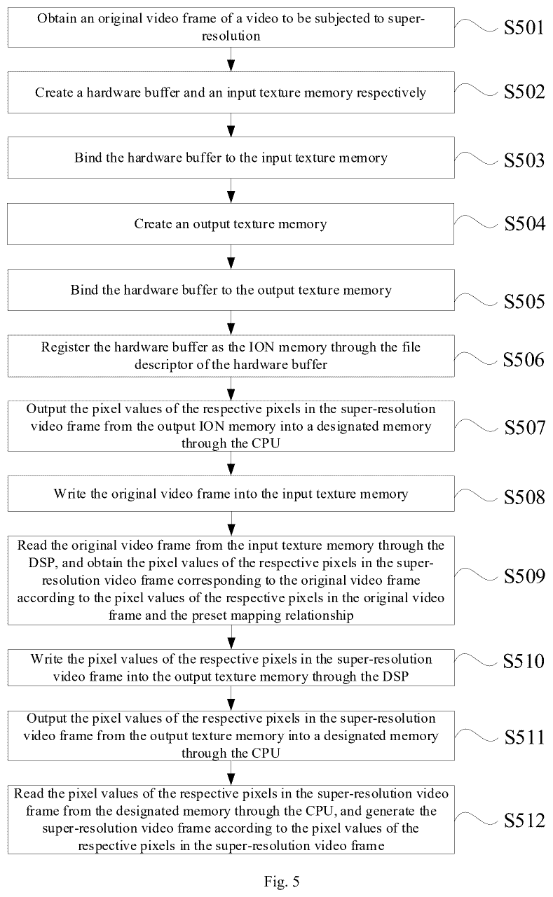

Referring to FIG. 5, when obtaining the pixel values of the respective pixels in the super-resolution video frame corresponding to the original video frame according to the pixel values of the respective pixels in the original video frame and the preset mapping relationship based on the DSP, the video super-resolution method provided in the embodiments of the present disclosure further includes the following steps:
S501: Obtaining an original video frame of a video to be subjected to super-resolution;
S502: Creating a hardware buffer and an input texture memory respectively.

Specifically, the hardware buffer is a memory that can be read and written by the CPU.
S503: Bind the hardware buffer to the input texture memory.

Since the embodiments of the present disclosure bind the hardware buffer to the input texture memory, the data in the input texture memory may be directly read by reading the data in the hardware buffer.
S505: Create an output texture memory.
S506: Bind the hardware buffer to the input texture memory.

Since the embodiments of the present disclosure bind the hardware buffer to the output texture memory, data may be directly written to the output texture memory by writing the data to the hardware buffer.
S507: Register the hardware buffer as the ION memory through the file descriptor (FD) of the hardware buffer.

In some embodiments, the foregoing memory can be directly registered on the DSP through the API of the DSP.

Since the embodiments of the present disclosure further register the hardware buffer as the ION memory, the DSP can access the hardware buffer to access the input texture memory and the output texture memory, thereby avoiding data reproduction in the process of accessing the input texture memory and the output texture memory by the DSP, and improving the efficiency of video super-resolution.
S508: Write the original video frame into the input texture memory.
S509: Read the original video frame from the input texture memory through the DSP, and obtain the pixel values of the respective pixels in the super-resolution video frame corresponding to the original video frame according to the pixel values of the respective pixels in the original video frame and the preset mapping relationship.
S510: Write the pixel values of the respective pixels in the super-resolution video frame into the output texture memory through the DSP.
S511: Output the pixel values of the respective pixels in the super-resolution video frame from the output texture memory into a designated memory through the CPU.
S512: Read the pixel values of the respective pixels in the super-resolution video frame from the designated memory through the CPU, and generate the super-resolution video frame according to the pixel values of the respective pixels in the super-resolution video frame.

Through the embodiment shown in FIG. 5 above, the embodiments of the present disclosure use the DSP for heterogeneous computing to provide high-quality video super-resolution, and avoids reproduction of video frame data while providing high-quality video super-resolution, thereby improving the efficiency of video super-resolution.

In some embodiments, an implementation method of the preceding step S12 (obtaining the pixel values of the respective pixels in the super-resolution video frame corresponding to the original video frame according to the pixel values of the respective pixels in the original video frame and the preset mapping relationship) includes: obtaining the pixel values of the respective pixels in the super-resolution video frame corresponding to the original video frame according to the pixel values of the respective pixels in the original video frame and the preset mapping relationship based on GPU, DSP, and a preset task assignment policy.

The preset task assignment policy may assign video super-resolution tasks to the GPU or DSP based on the number of tasks and performance of the GPU or DSP. For example, in response to the super-resolution video being a 3D video, a super-resolution task corresponding to a left view and a super-resolution task corresponding to a right view may be assigned to the GPU and DSP, respectively.

The implementation method of obtaining the pixel values of the respective pixels in the super-resolution video frame corresponding to the original video frame according to the pixel values of the respective pixels in the original video frame and the preset mapping relationship based on GPU can refer to embodiments shown in FIG. 3. The implementation method of obtaining the pixel values of the respective pixels in the super-resolution video frame corresponding to the original video frame according to the pixel values of the respective pixels in the original video frame and the preset mapping relationship based on DSP can refer to embodiments shown in FIG. 4 or FIG. 5. Therefore, they are not described again here.

Based on the same inventive concept, as an implementation of the above method, the embodiments of the present disclosure also provide a video super-resolution apparatus. This embodiment corresponds to the foregoing method embodiment, and for ease of reading, the details of the foregoing method embodiment will not be described one by one in the present embodiment. However, it should be clear that the video super-resolution apparatus in the present embodiment may correspond to the realization of all the contents of the foregoing method embodiment.

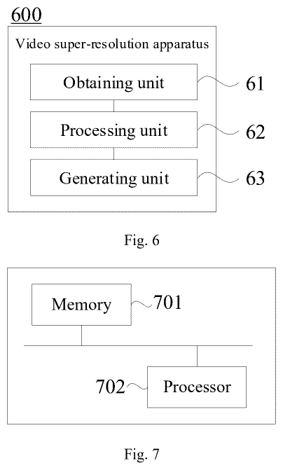

The embodiments of the present disclosure provide a video super-super-resolution apparatus. FIG. 6 is a structural schematic diagram of the video super-resolution apparatus. As shown in FIG. 6, the video super-resolution apparatus 600 includes:
an obtaining unit 61 configured to obtain an original video frame of a video to be subjected to super-resolution;
a processing unit 62 configured to obtain pixel values of respective pixels in a super-resolution frame corresponding to the original video frame according to pixel values of respective pixels in the original video frame and a preset mapping relationship; where the preset mapping relationship is a mapping relationship generated according to pixel values of pixels in an input video frame of a video super-resolution network model and pixel values of pixels in an output video frame of the video super-resolution network model, and the video super-resolution network model is a model obtained by training a preset machine learning model based on a model training sample;
a generating unit 63 configured to generate the super-resolution video frame according to the pixel values of the respective pixels in the super-resolution video frame.

As an optional implementation of the embodiments of the present disclosure, the processing unit 62 is specifically configured to obtain the pixel values of the respective pixels in the super-resolution video frame corresponding to the original video frame according to the pixel values of the respective pixels in the original video frame and the preset mapping relationship based on a graphics processing unit (GPU); or obtain the pixel values of the respective pixels in the super-resolution video frame corresponding to the original video frame according to the pixel values of the respective pixels in the original video frame and the preset mapping relationship based on a digital signal processor (DSP); or obtain the pixel values of the respective pixels in the super-resolution video frame corresponding to the original video frame according to the pixel values of the respective pixels in the original video frame and the preset mapping relationship based on a graphics processing unit, a digital signal processor and a preset task assignment policy.

As an optional implementation of the present embodiment, the processing unit 62 is specifically configured to create an input texture memory; configure the input texture memory so that an OpenCL of the GPU can access the input texture memory; write the original video frame into the input texture memory; read the original video frame from the input texture memory through the OpenCL, and obtain the pixel values of the respective pixels in the super-resolution video frame corresponding to the original video frame according to the pixel values of the respective pixels in the original video frame and the preset mapping relationship.

As an optional implementation of the embodiments of the present disclosure, the generating unit 63 is specifically configured to create an output texture memory; configure the output texture memory so that the OpenCL can access the input texture memory; write the pixel values of the respective pixels in the super-resolution video frame into the output texture memory through the OpenCL; output the pixel values of the respective pixels in the super-resolution video frame from the output texture memory to a designated memory through a central processing unit (CPU); read the pixel values of the respective pixels in the super-resolution video frame from the designated memory; and generate the super-resolution video frame according to the pixel values of the respective pixels in the super-resolution video frame.

As an optional implementation of the embodiments of the present disclosure, the processing unit 62 is specifically configured to create an input ION memory; write the original video frame into the input ION memory; read the original video frame from the input ION memory through the DSP, and obtain the pixel values of the respective pixels in the super-resolution video frame corresponding to the original video frame according to the pixel values of the respective pixels in the original video frame and the preset mapping relationship.

As an optional implementation of the embodiments of the present disclosure, the generating unit 63 is specifically configured to create an output ION memory; write the pixel values of the respective pixels in the super-resolution video frame into the output ION memory through the DSP; output the pixel values of the respective pixels in the super-resolution video frame from the output ION memory to a designated memory through the CPU; read the pixel values of the respective pixels in the super-resolution video frame from the designated memory; and generate the super-resolution video frame according to the pixel values of the respective pixels in the super-resolution video frame.

As an optional implementation of the embodiments of the present disclosure, the processing unit 62 is specifically configured to create a hardware buffer and an input texture memory; bind the hardware buffer to the input texture memory; register the hardware buffer as an ION memory through the file descriptor (FD) of the hardware buffer; write the original video frame into the input texture memory; read the original video frame from the input texture memory through the DSP, and obtain the pixel values of the respective pixels in the super-resolution video frame corresponding to the original video frame according to the pixel values of the respective pixels in the original video frame and the preset mapping relationship.

As an optional implementation of the embodiments of the present disclosure, the generating unit 63 is specifically configured to create an output texture memory; bind the hardware buffer to the input texture memory; write the pixel values of the respective pixels in the super-resolution video frame into the output texture memory through the DSP; output the pixel values of the respective pixels in the super-resolution video frame from the output texture memory to a designated memory through the CPU; read the pixel values of the respective pixels in the super-resolution video frame from the designated memory; and generate the super-resolution video frame according to the pixel values of respective pixels in the super-resolution video frame.

The video super-resolution apparatus provided in this embodiment may implement the foregoing video super-resolution method provided in the above method embodiments, with the same implementation principle and technical effect, which are not described again here.

Based on the same inventive concept, the embodiments of the present disclosure also provide an electronic device. FIG. 7 is a structural schematic diagram of an electronic device provided in the embodiments of the present disclosure. As shown in FIG. 7, the electronic device provided in the present embodiment includes: a memory 701 and a processor 702, where the memory 701 is configured to store a computer program; the processor 702 is configured to execute the video super-resolution method provided in the foregoing embodiments when executing the computer program.

Based on the same inventive concept, the foregoing embodiments of the present disclosure also provide a computer-readable storage medium on which a computer program is stored, where the computer program, when being executed by a processor, enables the computing device to implement the video super-resolution method provided in the foregoing embodiments.

Based on the same inventive concept, the embodiments of the present disclosure also provide a computer program product, where the computer program product, when being run on a computer, enables the computing device to implement the video super-resolution method provided in the foregoing embodiments.

It should be appreciated by those skilled in the art that the embodiments of the present disclosure may be embodied as a method, a system, or a computer program product. Accordingly, the present disclosure may be embodied in the form of a complete hardware embodiment, a complete software embodiment, or a combination of software and hardware embodiments. Furthermore, the present disclosure may be embodied in the form of a computer program product implemented on one or more computer-available storage media containing computer-usable program codes.

The processor may be a central processing unit (CPU) 103, or other general-purpose processors, a digital signal processor (DSP), an application specific integrated circuit (ASIC), a field-programmable gate array (FPGA) or other programmable logic devices, discrete gate or transistor logic devices, discrete hardware components, or the like. A general-purpose processor may be a microprocessor, or the processor may be any regular processor, or the like.

The memory may include non-permanent memory in computer-readable media, in forms such as random access memory (RAM) and/or non-volatile memory, such as read-only memory (ROM) or flash memory (flash RAM). The memory is an example of computer-readable media.

Computer-readable media includes permanent and non-permanent, removable and non-removable storage media. Storage media can implement information storage by any method or technology. Information can be computer-readable instructions, data structures, program modules or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette tapes, magnetic disk storage or other magnetic storage devices or any other non-transmission medium that can be used to store information that can be accessed by computing devices. According to the definition in this present application, computer-readable media does not include transitory media such as modulated data signals and carrier waves.

Finally, it should be noted that: each of the above embodiments is only used to illustrate the technical solution of the present disclosure, not to limit it; although the present disclosure has been described in detail with reference to the foregoing embodiments, those of ordinary skill in the art should understand that: they can still modify the technical solutions recorded in the foregoing embodiments, or make equivalent replacements for some or all of the technical features; and these modifications or replacements do not make the essence of the corresponding technical solutions deviate from the scope of the technical solutions of the various embodiments of the present disclosure.

1. A video super-resolution method, comprising:
obtaining an original video frame of a video to be subjected to super-resolution;
obtaining pixel values of respective pixels in a super-resolution frame corresponding to the original video frame according to pixel values of respective pixels in the original video frame and a preset mapping relationship; wherein the preset mapping relationship is a mapping relationship generated according to pixel values of pixels in an input video frame of a video super-resolution network model and pixel values of pixels in an output video frame of the video super-resolution network model, and the video super-resolution network model is a model obtained by training a preset machine learning model based on a model training sample; and
generating the super-resolution video frame according to the pixel values of the respective pixels in the super-resolution video frame.

2. The method according to claim 1, wherein obtaining the pixel values of the respective pixels in the super-resolution frame corresponding to the original video frame according to the respective pixel values of the respective pixels in the original video frame and the preset mapping relationship comprises:
obtaining the pixel values of the respective pixels in the super-resolution video frame corresponding to the original video frame according to the pixel values of the respective pixels in the original video frame and the preset mapping relationship based on a graphics processing unit (GPU); or
obtaining the pixel values of the respective pixels in the super-resolution video frame corresponding to the original video frame according to the pixel values of the respective pixels in the original video frame and the preset mapping relationship based on a digital signal processor (DSP); or
obtaining the pixel values of the respective pixels in the super-resolution video frame corresponding to the original video frame according to the pixel values of the respective pixels in the original video frame and the preset mapping relationship based on a graphics processing unit, a digital signal process, and a preset task assignment policy.

3. The method according to claim 2, wherein obtaining the pixel values of the respective pixels in the super-resolution video frame corresponding to the original video frame according to the pixel values of the respective pixels in the original video frame and the preset mapping relationship based on the graphics processing unit (GPU) comprises:
creating an input texture memory;
configuring the input texture memory so that an open computing language (OpenCL) of the GPU is capable of accessing the input texture memory;
writing the original video frame into the input texture memory;
reading the original video frame from the input texture memory through the OpenCL; and
obtaining the pixel values of the respective pixels in the super-resolution video frame corresponding to the original video frame according to the pixel values of the respective pixels in the original video frame and the preset mapping relationship.

4. The method according to claim 3, wherein generating the super-resolution video frame according to the pixel values of the respective pixels in the super-resolution video frame comprises:
creating an output texture memory;
configuring the output texture memory so that the OpenCL is capable of accessing the input texture memory;
writing the pixel values of the respective pixels in the super-resolution video frame into the output texture memory through the OpenCL;
outputting the pixel values of the respective pixels in the super-resolution video frame from the output texture memory to a designated memory through a central processing unit CPU, and reading the pixel values of the respective pixels in the super-resolution video frame from the designated memory; and
generating the super-resolution video frame according to the pixel values of the respective pixels in the super-resolution video frame.

5. The method according to claim 2, wherein obtaining the pixel values of the respective pixels in the super-resolution video frame corresponding to the original video frame according to the pixel values of the respective pixels in the original video frame and the preset mapping relationship based on the digital signal processor DSP comprises:
creating an input/output zero-copy ION memory;
writing the original video frame into the input ION memory;
reading the original video frame from the input ION memory through the DSP; and
obtaining the pixel values of the respective pixels in the super-resolution video frame corresponding to the original video frame according to the pixel values of the respective pixels in the original video frame and the preset mapping relationship.

6. The method according to claim 5, wherein obtaining the pixel values of the respective pixels in the super-resolution frame corresponding to the original video frame according to the pixel values of the respective pixels in the original video frame and the preset mapping relationship comprises:
creating an output ION memory;
writing the pixel values of the respective pixels in the super-resolution video frame into the output ION memory through the DSP;
outputting the pixel values of the respective pixels in the super-resolution video frame from the output ION memory to a designated memory through the CPU, and reading the pixel values of the respective pixels in the super-resolution video frame from the designated memory through the CPU; and
generating the super-resolution video frame according to the pixel values of the respective pixels in the super-resolution video frame.

7. The method according to claim 5, wherein obtaining the pixel values of the respective pixels in the super-resolution frame corresponding to the original video frame according to the pixel values of the respective pixels in the original video frame and the preset mapping relationship comprises:
creating a hardware buffer and an input texture memory respectively;
binding the hardware buffer to the input texture memory;
registering the hardware buffer as an ION memory through a file descriptor (FD) of the hardware buffer;
writing the original video frame into the input texture memory;
reading the original video frame from the input texture memory through the DSP, and obtaining the pixel values of the respective pixels in the super-resolution video frame corresponding to the original video frame according to the pixel values of the respective pixels in the original video frame and the preset mapping relationship.

8. The method according to claim 7, wherein obtaining the pixel values of the respective pixels in the super-resolution frame corresponding to the original video frame according to the pixel values of the respective pixels in the original video frame and the preset mapping relationship comprises:
creating an output texture memory;
binding the hardware buffer to the output texture memory;
writing the pixel values of the respective pixels in the super-resolution video frame into the output texture memory through the DSP;
outputting the pixel values of the respective pixels in the super-resolution video frame from the output texture memory into a designated memory through the CPU, reading the pixel values of the respective pixels in the super-resolution video frame from the designated memory through the CPU, and generating the super-resolution video frame according to the pixel values of the respective pixels in the super-resolution video frame.

9. (canceled)

10. An electronic device, comprising: a memory and a processor, wherein the memory is configured to store a computer program; the processor is configured to execute the computer program that enables the electronic device to implement a video super-resolution method, which comprises:
obtaining an original video frame of a video to be subjected to super-resolution;
obtaining pixel values of respective pixels in a super-resolution frame corresponding to the original video frame according to pixel values of respective pixels in the original video frame and a preset mapping relationship; wherein the preset mapping relationship is a mapping relationship generated according to pixel values of pixels in an input video frame of a video super-resolution network model and pixel values of pixels in an output video frame of the video super-resolution network model, and the video super-resolution network model is a model obtained by training a preset machine learning model based on a model training sample; and
generating the super-resolution video frame according to the pixel values of the respective pixels in the super-resolution video frame.

11. A non-transient computer-readable storage medium with a computer program stored thereon, wherein the computer program, when being executed by a computing device, enables the computing device to implement a video super-resolution method, which comprises:
obtaining an original video frame of a video to be subjected to super-resolution;
obtaining pixel values of respective pixels in a super-resolution frame corresponding to the original video frame according to pixel values of respective pixels in the original video frame and a preset mapping relationship; wherein the preset mapping relationship is a mapping relationship generated according to pixel values of pixels in an input video frame of a video super-resolution network model and pixel values of pixels in an output video frame of the video super-resolution network model, and the video super-resolution network model is a model obtained by training a preset machine learning model based on a model training sample; and
generating the super-resolution video frame according to the pixel values of the respective pixels in the super-resolution video frame.

12. The electronic device according to claim 10, wherein obtaining the pixel values of the respective pixels in the super-resolution frame corresponding to the original video frame according to the respective pixel values of the respective pixels in the original video frame and the preset mapping relationship comprises:
obtaining the pixel values of the respective pixels in the super-resolution video frame corresponding to the original video frame according to the pixel values of the respective pixels in the original video frame and the preset mapping relationship based on a graphics processing unit (GPU); or
obtaining the pixel values of the respective pixels in the super-resolution video frame corresponding to the original video frame according to the pixel values of the respective pixels in the original video frame and the preset mapping relationship based on a digital signal processor (DSP); or
obtaining the pixel values of the respective pixels in the super-resolution video frame corresponding to the original video frame according to the pixel values of the respective pixels in the original video frame and the preset mapping relationship based on a graphics processing unit, a digital signal process, and a preset task assignment policy.

13. The electronic device according to claim 12, wherein obtaining the pixel values of the respective pixels in the super-resolution video frame corresponding to the original video frame according to the pixel values of the respective pixels in the original video frame and the preset mapping relationship based on the graphics processing unit (GPU) comprises:
creating an input texture memory;
configuring the input texture memory so that an open computing language (OpenCL) of the GPU is capable of accessing the input texture memory;
writing the original video frame into the input texture memory;
reading the original video frame from the input texture memory through the OpenCL; and
obtaining the pixel values of the respective pixels in the super-resolution video frame corresponding to the original video frame according to the pixel values of the respective pixels in the original video frame and the preset mapping relationship.

14. The electronic device according to claim 13, wherein generating the super-resolution video frame according to the pixel values of the respective pixels in the super-resolution video frame comprises:
creating an output texture memory;
configuring the output texture memory so that the OpenCL is capable of accessing the input texture memory;
writing the pixel values of the respective pixels in the super-resolution video frame into the output texture memory through the OpenCL;
outputting the pixel values of the respective pixels in the super-resolution video frame from the output texture memory to a designated memory through a central processing unit CPU, and reading the pixel values of the respective pixels in the super-resolution video frame from the designated memory; and
generating the super-resolution video frame according to the pixel values of the respective pixels in the super-resolution video frame.

15. The electronic device according to claim 12, wherein obtaining the pixel values of the respective pixels in the super-resolution video frame corresponding to the original video frame according to the pixel values of the respective pixels in the original video frame and the preset mapping relationship based on the digital signal processor DSP comprises:
creating an input/output zero-copy ION memory;
writing the original video frame into the input ION memory;
reading the original video frame from the input ION memory through the DSP; and
obtaining the pixel values of the respective pixels in the super-resolution video frame corresponding to the original video frame according to the pixel values of the respective pixels in the original video frame and the preset mapping relationship.

16. The electronic device according to claim 15, wherein obtaining the pixel values of the respective pixels in the super-resolution frame corresponding to the original video frame according to the pixel values of the respective pixels in the original video frame and the preset mapping relationship comprises:
creating an output ION memory;
writing the pixel values of the respective pixels in the super-resolution video frame into the output ION memory through the DSP;
outputting the pixel values of the respective pixels in the super-resolution video frame from the output ION memory to a designated memory through the CPU, and reading the pixel values of the respective pixels in the super-resolution video frame from the designated memory through the CPU; and
generating the super-resolution video frame according to the pixel values of the respective pixels in the super-resolution video frame.

17. The electronic device according to claim 15, wherein obtaining the pixel values of the respective pixels in the super-resolution frame corresponding to the original video frame according to the pixel values of the respective pixels in the original video frame and the preset mapping relationship comprises:
creating a hardware buffer and an input texture memory respectively;
binding the hardware buffer to the input texture memory;
registering the hardware buffer as an ION memory through a file descriptor (FD) of the hardware buffer;
writing the original video frame into the input texture memory;
reading the original video frame from the input texture memory through the DSP, and obtaining the pixel values of the respective pixels in the super-resolution video frame corresponding to the original video frame according to the pixel values of the respective pixels in the original video frame and the preset mapping relationship.

18. The electronic device according to claim 17, wherein obtaining the pixel values of the respective pixels in the super-resolution frame corresponding to the original video frame according to the pixel values of the respective pixels in the original video frame and the preset mapping relationship comprises:
creating an output texture memory;
binding the hardware buffer to the output texture memory;
writing the pixel values of the respective pixels in the super-resolution video frame into the output texture memory through the DSP;
outputting the pixel values of the respective pixels in the super-resolution video frame from the output texture memory into a designated memory through the CPU, reading the pixel values of the respective pixels in the super-resolution video frame from the designated memory through the CPU, and generating the super-resolution video frame according to the pixel values of the respective pixels in the super-resolution video frame.
